(19) United States
(12) Patent Application Publication
(10) Pub. No.: US 2026/0070774 A1
(43) Pub. Date: Mar. 12, 2026

(54) MULTIPURPOSE VENTED FUNNEL

(71) Applicants: Jeffrey Flowers, Grass Valley, CA (US); Karen Flowers, Grass Valley, CA (US)

(72) Inventors: Jeffrey Flowers, Grass Valley, CA (US); Karen Flowers, Grass Valley, CA (US)

(21) Appl. No.: 18/827,735

(22) Filed: Sep. 7, 2024

(51) Int. Cl. B67C 11/02; B67C 11/00

(52) U.S. Cl. CPC B67C 11/02; B67C 2011/30

(57) ABSTRACT

A multipurpose vented funnel is a device for funneling liquid, wherein the device includes a conical hollow body, having a wide top opening, directed into a smaller outlet spout. The inner wall of the conical hollow body includes a linear pattern of grooves, extending horizontally from the top of the inner wall to the bottom. The outer wall of the conical hollow body has a handle, which is part of a rectangular passageway for the venting of air or gas, from a reservoir and/or container. In addition, a plurality of stabilizer tabs, outwardly project from the outlet spout for the stable supporting of the funnel inside or reservoirs and/or containers.

### FIELD OF THE INVENTION

The present invention relates to a funnel, having multiple features and functions, and more particularly, a multipurpose vented funnel, having an integrated self-venting system for use in filling reservoirs and/or containers.

### BACKGROUND OF THE INVENTION

Conventional funnels are typically used to facilitate the pouring of liquids, powders, or any other filler material, into reservoirs and/or containers that have multiple size openings. A funnel typically includes inverted hollow cones, or tapering or cylindrical tubes, having a wide opening at the top and a narrow spout at the bottom, to be fitted into the openings of associated receptacles into which material is to be poured.

Closed or sealed fluid systems such as the cooling or oil system of a motor vehicle, include a fill port or nozzle through which fluids are introduced or added. Similarly, containers such as bottles, include an opening through which the fluid or solid material is introduced to fill the container. It is common practice to use a funnel, inserted into the container, opening or system port/nozzle, to fill or add the material to these containers or sealed systems.

Funnels are often used in the filling process of liquid, powder, and/or filler material, into household containers. Funnels are commonly known, and used, to prevent spilling in pouring liquids into containers with small openings. A household funnel may include a small tapering tube with a wide cone shaped mouth; however this common design often leads to liquid overflow.

In food dispensing establishments, such as restaurants, cafeterias, luncheonettes, and coffee shops, one may see problems arise in the use of relatively viscus liquid condiments, such as ketchup, mustard, and the like. For example, conventional packaging in these condiments are usually done in clear glass bottles, having a relatively narrow neck. In view of the foregoing aspects, traditional funnels are undesirable from many reasons. Specifically, when fluids have a higher viscosity, they tend to take much longer to drain through the bottom of the funnel and into the bottle/container, usually with considerable purging, burping and backsplash, which can cause spilling and liquid back up.

Furthermore, in conventional funnels, venting is accomplished in one of two ways. Number one, venting is accomplished primarily through the fill hole in the funnel. That is, the funnels fill hole is used to add material to the container/system, as well as to vent the air. Depending upon the sealing ability of the funnel to the opening/nozzle, some venting also may occur in the space between the funnel and the inside surface of the opening port or nozzle. Secondly, the funnel is held, so it does not contact the nozzle or opening while adding the material, this leaves the space between the funnel and the inside surface of the opening port or nozzle in which the funnel is inserted. The air from the container vents through this space.

In view of the above descriptions, traditional funnels are undesirable for many reasons, specifically when liquid backs up inside of the funnel, it can cause unwanted spillage, due once the air traps inside the reservoir and/or container. The multipurpose vented funnel eliminates this issue.

### BRIEF DESCRIPTION OF THE INVENTION

The primary object of the present invention is to provide a multipurpose vented funnel with a self-contained venting system, which is designed to rapidly vent air or gas, in a safe manner, from a container being filled, without being splashed or without spilling liquid.

In order to achieve this aspect, the present invention includes a vent passageway within the funnel's conical member and handle's structure, between the inner and outer walls, of said invention. The passageway is preferably elongated and substantially rectangular in shape.

The present invention includes a funnel portion for receiving liquid, vented, rectangular handle for preventing liquid back up in the funnel portion, and an outlet spout with an end for delivery liquid therefrom.

The present invention may further include, within the funnel's inner sidewall, conical grooves to prevent the spatters and/or blockage, extending linearly and generally vertically from the top of the funnel opening to the top of the downspout.

Yet another aspect of the invention, the downspout of the funnel includes stabilizing tabs outwardly projected from the downspout, to aid in the stability and supporting of the funnel, in a generally upright orientation when positioned within an opening of a receiving container.

The present invention solves the problems of conventional funnels by improving a typical funnel's functionality. The multipurpose vented funnel accommodates various functions within the household, auto, restaurants, etc., while incorporating different sizes, and a means for the air to escape out of a container/reservoir in which a funnel is being used.

These and other features and advantages of the invention will be readily apparent from the following detailed description of an embodiment thereof and reference to the accompanying drawings.

### BRIEF DESCRIPTION OF THE DRAWING

FIG. 1 is a front schematic view of the multipurpose vented funnel in accordance with the present embodiment of the invention.

FIG. 2 is a top view of the funnel.

FIG. 3 is a side view of the funnel illustrating the rectangular vent passageway.

FIG. 4 is a view of the funnel handle.

FIG. 5 is an image of the bottom view of the funnel, demonstrating the vent in relation to the outlet spout.

### DESCRIPTION OF CERTAIN EMBODIMENT OF THE PRESENT INVENTION

In the following detailed description of the preferred embodiment references made to the accompanying drawings, which form a part of this application. The drawing show by way of illustration, specific embodiments in which the invention may be practiced. It is to be understood that other embodiments may be utilized, and structural changes may be made without departing from the scope of the present invention.

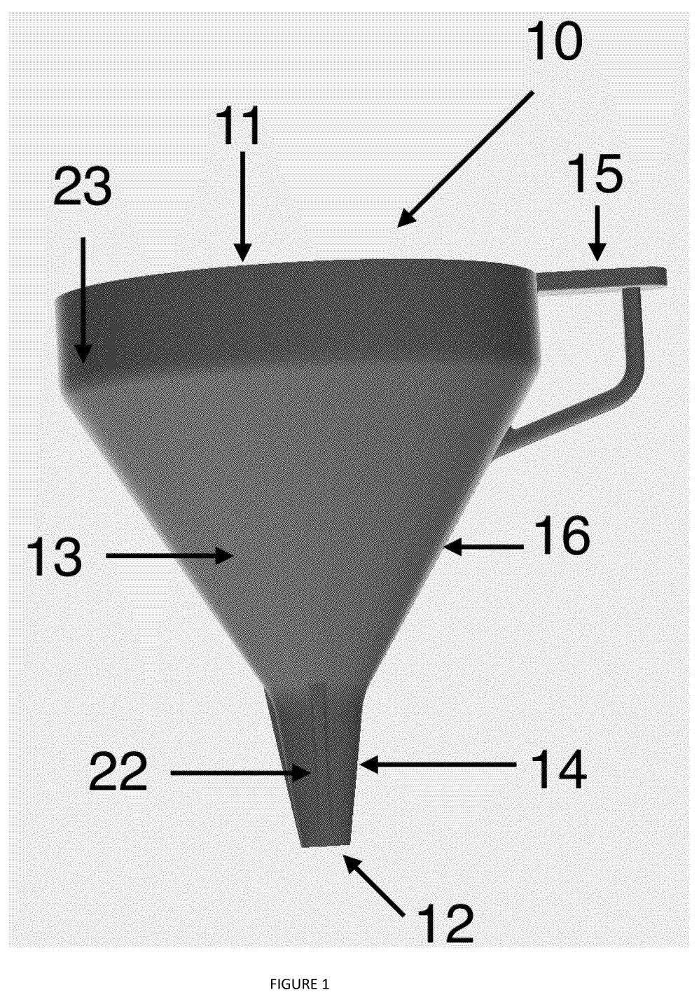

The present invention shown in FIG. 1 illustrates the multipurpose vented funnel 10 which includes a top end opening 11 for receiving liquid, an overflow guard 23, and a bottom opening 12 for the dispense of said liquid. Also, a conical hollow body 13 elongating into an outlet spout 14, a handle 15 attached to the outer wall 16. On the outlet spout 14, includes a series of stabilizer tabs 22.

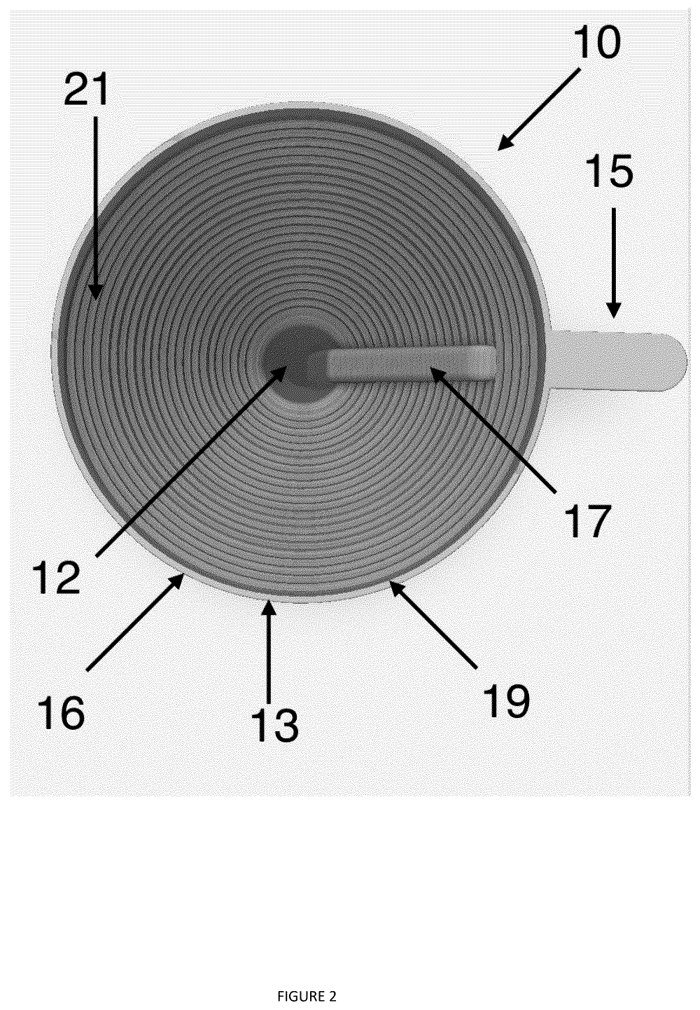

As shown in FIG. 2 a top view of the multipurpose vented funnel 10 having a conical hollow body 13 with a handle 15 attached on the outer wall 16 rectangular vent passageway 17 terminating at the bottom opening 12. Inside, the horizontal linear grooves 21 are extended along the inner wall 19.

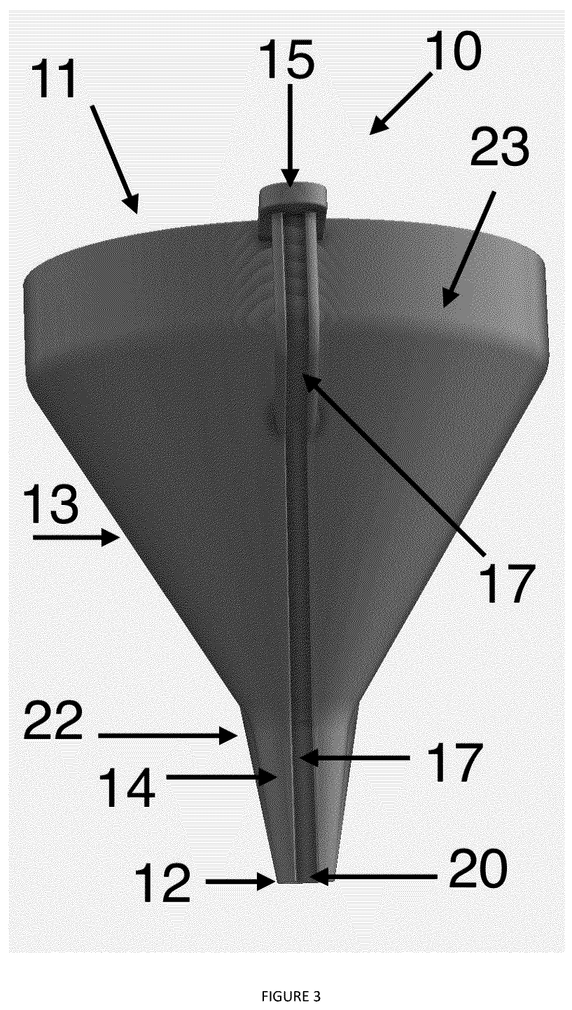

FIG. 3, a view of the multipurpose vented funnel 10 showing the top opening 11, the bottom opening 12, and the vent passageway 17 traveling from the handle 15 down the overflow guard 23 and the conical hollow body 13 to the outlet spout 14 and ending where the air intake 20 is located. Included in the illustration, is stabilizer tabs 22 projecting along the outlet spout 14.

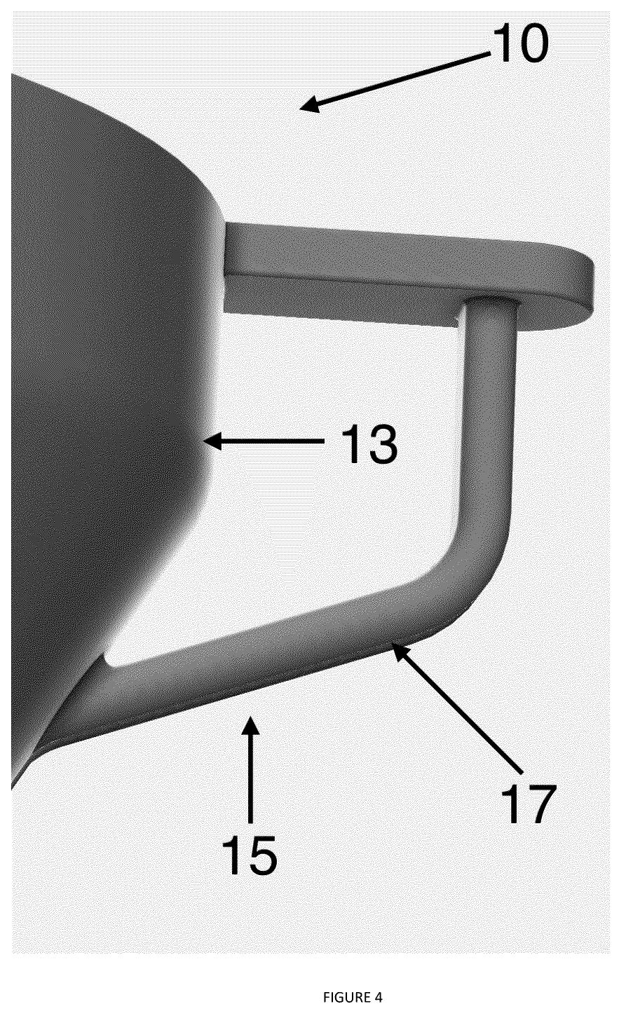

FIG. 4 the multipurpose vented funnel 10 illustrates the conical hollow body's 13 handle 15 which the rectangular vent passageway 17 sits inside of.

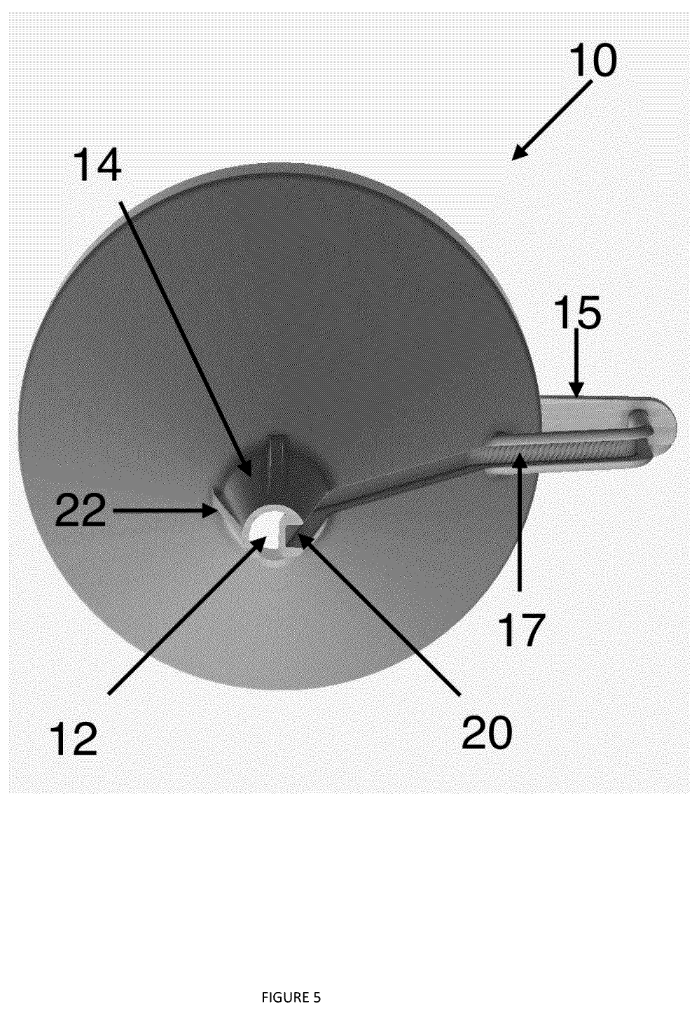

As best seen in FIG. 5 a view of the multipurpose vented funnel 10 bottom having a rectangular vent passageway 17 located within the handle 15 all the way to the bottom of the outlet spout 14, which also includes a series of stabilizer tabs 22. In this image you can clearly see the air intake 20, adjacent from the bottom opening 12 in which the multipurpose vented funnel 10 allows air to escape, while filling a reservoir and/or container.

1. A multipurpose vented funnel comprising of a conical hollow body, having a wide inlet and a narrow outlet spout. An inner and outer wall surface extending from the wide inlet to the narrow outlet spout. A handle extending from the top of the outer wall of the conical hollow body to the middle of the conical hollow body, creates a gap, between the top of the vent and/or the outer handle, and the opening of the outer wall and/or the hollow conical body. The narrow outlet spout at the bottom of the conical hollow body includes stabilizing strips, projecting on the exterior surface of the spout, to aid the multipurpose vented funnel in its stability, while sitting inside of the various container/reservoir openings. Also included in the multipurpose vented funnel, is a rectangular vent passageway, extending along the top of the conical hollow body to the bottom of the outlet spout, wherein it is a trench shaped vent, open along its entire length.

2. The multipurpose vented funnel of claim 1, where in the conical hollow body includes grooves, extending along the inner wall surface, in a linear pattern, in a spaced relation from each other, and arranged such, that the grooves prevent splatters and blockage during transfer of material during the use of the multipurpose vented funnel.

3. The multipurpose vented funnel, wherein an integrated self-venting system is provided for use in filling reservoirs and/or containers.
